(19) United States
(12) Patent Application Publication
(10) Pub. No.: US 2007/0074202 A1
(43) Pub. Date: Mar. 29, 2007

(54) Program product installation

(75) Inventors: Paul F. McMahan, Apex, NC (US); Steven P. Kim, Raleigh, NC (US); Anne F. Ross, Cary, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/235,950

(22) Filed: Sep. 27, 2005

(51) Int. Cl. G06F 9/445

(52) U.S. Cl. 717/174

(57) ABSTRACT

A solution for generating an installation medium for a program product is provided. A runtime profile for a customer is used to recreate the customer's runtime environment. The program product is installed in the recreated runtime environment and it is tested to ensure that the program product operates as intended in the recreated runtime environment. A custom installation medium is generated based on the installed program product.

### BACKGROUND OF THE INVENTION

1. Technical Field

The invention relates generally to installing a program product, and more particularly, to a solution for generating an installation medium for the program product.

2. Background Art

Complex software products often require one or more middleware components when installed. As a result, a software vendor will frequently include installation media for the required middleware component(s) along with the installation medium for the software product. In this case, the various install programs for the middleware and software product may need to be executed in a very careful manner to properly account for the various hardware, middleware, and configuration options available to the end user. This problem is enhanced when a software vendor, such as International Business Machines Corp. of Armonk, N.Y. (IBM), assembles applications from various reusable components, each with its own set of install and configuration options. For example, version 3.1 of IBM's Tivoli Business Systems Manager requires over twenty-five compact discs (CDs) and a relatively complex manual for a full installation. To this extent, a software vendor frequently will send an expert to a customer location in order to complete the installation.

Additionally, there are countless possible runtime environments in which an end user may seek to install a software product. To this extent, a software vendor cannot readily recreate and test the software product in each possible runtime environment prior to releasing the product. As a result, the software vendor is forced to estimate system requirements for the software product and make certain assumptions about the runtime environments in which the software product can properly execute. Occasionally, these estimates and/or assumptions are inaccurate, causing the end user to become frustrated and lose confidence in the software vendor, while increasing the software vendor's support costs.

To this extent, a need exists for an improved solution for installing a program product in which the installation medium for the program product can be generated based on a target runtime environment.

### SUMMARY OF THE INVENTION

The invention provides a solution for generating an installation medium for a program product. A runtime profile for a customer is used to recreate the customer's runtime environment. The program product is installed in the recreated runtime environment and it is tested to ensure that the program product operates as intended in the recreated runtime environment. A custom installation medium is generated based on the installed program product. The custom installation medium then can be provided to the customer for installing the program product in the customer's runtime environment. The custom installation medium also can include any ancillary program product(s) that require installation in the customer's runtime environment in order for the program product to execute properly. In one embodiment, the custom installation medium comprises an image of the installed program product and/or ancillary program product(s). The invention enables a software vendor to ensure that the program product should work in the target runtime environment. Further, the recreated runtime environment can be used to provide support for the customer after installation of the program product. In this manner, the software vendor can provide improved customer support while requiring fewer individuals to be present at the customer's site.

A first aspect of the invention provides a method of generating an installation medium for a program product, the method comprising: determining whether a runtime profile for a customer is available; and when the runtime profile is available: recreating a runtime environment of the customer based on the runtime profile; installing the program product in the runtime environment; ensuring that the program product is operable in the runtime environment; and generating a custom installation medium based on the installed program product.

A second aspect of the invention provides a system for generating an installation medium for a program product, the system comprising: a system for determining whether a runtime profile for a customer is available; and a system for generating a custom installation medium when the runtime profile is available, the system for generating including: a system for recreating a runtime environment of the customer based on the runtime profile; a system for installing the program product in the runtime environment; a system for ensuring that the program product is operable in the runtime environment; and a system for generating the custom installation medium based on the installed program product.

A third aspect of the invention provides a method of generating an installation medium for a program product, the method comprising: obtaining a runtime profile for a customer; recreating a runtime environment of the customer based on the runtime profile; installing the program product in the runtime environment; ensuring that the program product is operable in the runtime environment; and generating a custom installation medium based on the installed program product.

A fourth aspect of the invention provides a system for generating an installation medium for a program product, the system comprising: a system for obtaining a runtime profile for a customer; a system for recreating a runtime environment of the customer based on the runtime profile; a system for installing the program product in the runtime environment; a system for ensuring that the program product is operable in the runtime environment; and a system for generating a custom installation medium based on the installed program product.

A fifth aspect of the invention provides a program product stored on a computer-readable medium, the program product including program code for enabling a computer infrastructure to generate an installation medium for a program product by performing the steps of: determining whether a runtime profile for a customer is available; and generating a custom installation medium when the runtime profile is available, wherein the generating step includes: recreating a runtime environment of the customer based on the runtime profile; installing the program product in the runtime environment; ensuring that the program product is operable in the runtime environment; and generating the custom installation medium based on the installed program product.

A sixth aspect of the invention provides a program product stored on a computer-readable medium, the program product including program code for enabling a computer infrastructure to generate an installation medium for a program product by performing the steps of: obtaining a runtime profile for a customer; recreating a runtime environment of the customer based on the runtime profile; installing the program product in the runtime environment; ensuring that the program product is operable in the runtime environment; and generating a custom installation medium based on the installed program product.

A seventh aspect of the invention provides a method of deploying a system for generating an installation medium for a program product, the method comprising: generating a computer infrastructure operable to: determine whether a runtime profile for a customer is available; and when the runtime profile is available: recreate a runtime environment of the customer based on the runtime profile; install the program product in the runtime environment; ensure that the program product is operable in the runtime environment; and generate a custom installation medium based on the installed program product.

An eighth aspect of the invention provides a method of deploying a system for generating an installation medium for a program product, the method comprising: obtaining a runtime profile for a customer; recreating a runtime environment of the customer based on the runtime profile; installing the program product in the runtime environment; ensuring that the program product is operable in the runtime environment; and generating a custom installation medium based on the installed program product.

A ninth aspect of the invention provides a business method for generating an installation medium for a program product, the business method comprising managing a computer infrastructure that performs one or more of the steps described herein; and receiving payment based on the managing step.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative environment for generating an installation medium for a program product according to an embodiment of the invention.

FIG. 2 shows illustrative method steps for processing an order for a program product according to an embodiment of the invention.

FIG. 3 shows alternative method steps for processing an order for a program product according to an embodiment of the invention.

FIG. 4 shows illustrative method steps for generating a custom installation medium according to an embodiment of the invention.

FIG. 5 shows illustrative method steps for managing a runtime profile according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a solution for generating an installation medium for a program product. A runtime profile for a customer is used to recreate the customer's runtime environment. The program product is installed in the recreated runtime environment and it is tested to ensure that the program product operates as intended in the recreated runtime environment. A custom installation medium is generated based on the installed program product. The custom installation medium then can be provided to the customer for installing the program product in the customer's runtime environment. The custom installation medium also can include any ancillary program product(s) that require installation in the customer's runtime environment in order for the program product to execute properly. In one embodiment, the custom installation medium comprises an image of the installed program product and/or ancillary program product(s). The invention enables a software vendor to ensure that the program product should work in the target runtime environment. Further, the recreated runtime environment can be used to provide support for the customer after installation of the program product. In this manner, the software vendor can provide improved customer support while requiring fewer individuals to be present at the customer's site.

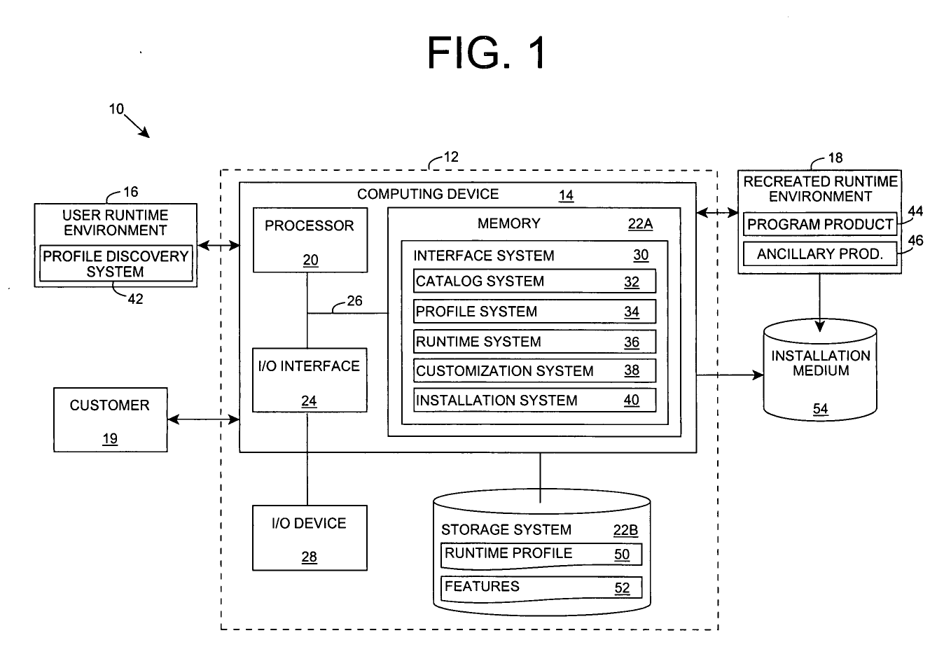

Turning to the drawings, FIG. 1 shows an illustrative environment 10 for generating an installation medium 54 for a program product 44. To this extent, environment 10 includes a computer infrastructure 12 that can perform the various process steps described herein for generating installation medium 54. In particular, computer infrastructure 12 is shown including a computing device 14 that comprises an interface system 30, which enables computing device 14 to generate installation medium 54 by performing the process steps described herein.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as interface system 30, that is stored in memory 22A and/or storage system 22B. While executing computer program code, processor 20 can read and/or write data, such as a runtime profile 50, to/from memory 22A, storage system 22B, and/or I/O interface 24. Bus 26 provides a communications link between each of the components in computing device 14. I/O device 28 can comprise any device that enables a user to interact with computing device 14 or any device that enables computing device 14 to communicate with one or more other computing devices.

In any event, computing device 14 can comprise any general purpose computing article of manufacture capable of executing computer program code installed thereon (e.g., a personal computer, server, handheld device, etc.). However, it is understood that computing device 14 and interface system 30 are only representative of various possible equivalent computing devices that may perform the various process steps of the invention. To this extent, in other embodiments, the functionality provided by computing device 14 and interface system 30 can be implemented by a computing article of manufacture that includes any combination of general and/or specific purpose hardware and/or computer program code. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of communications link. Further, a computing device, such as computing device 14, in computer infrastructure 12 communicates with one or more computing devices in a user runtime environment 16 over any type of communications link. As with computer infrastructure 12, user runtime environment 16 can comprise any type of computer infrastructure that comprises one or more computing devices. In any event, each communications link can comprise any combination of various types of wired and/or wireless communications links, such as a network, a shared memory, or the like. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

As discussed herein, interface system 30 enables computing infrastructure 12 to generate installation medium 54 for program product 44. To this extent, interface system 30 is shown including a catalog system 32, a profile system 34, a runtime system 36, a customization system 38, and an installation system 40. Operation of each of these systems is discussed further herein. However, it is understood that some of the various systems shown in FIG. 1 and/or functionality described in conjunction therewith can be implemented independently, combined, and/or stored in memory for one or more separate computing devices that are included in computer infrastructure 12. Further, it is understood that some of the systems and/or functionality may not be implemented, or additional systems and/or functionality may be included as part of environment 10.

Regardless, catalog system 32 can generate a product catalog for display to a customer 19. For example, catalog system 32 can generate a product catalog that can be accessed by customer 19 via a web site or the like. The product catalog can include various details on program product 44 and/or other program products offered by a software vendor. After viewing the product catalog, customer 19 can decide to order program product 44. Catalog system 32 can obtain the order information (e.g., payment, address, etc., information) using any known solution (e.g., entered via a web site, entered by an operator, etc.). When program product 44 is configurable, the order information obtained by catalog system 32 can further include a set of desired features 52 for the program product 44. Each feature 52 can comprise some functionality of program product 44 that is desired/required in the particular installation of program product 44 for customer 19.

Installation system 40 can generate installation medium 54 for program product 44. To this extent, installation medium 54 can comprise any computer-readable medium, and can include an installation program for installing the program code for program product 44 that implements the features 52 specified in the order information. Additionally, program product 44 may require one or more ancillary program products 46 to implement some or all of the functionality. In this case, installation medium 54 can further include an installation program for installing each required ancillary program product 46. Further, installation medium 54 can include installation instructions on the order in which ancillary program product(s) 46 and program product 44 should be installed and/or the features of ancillary program product(s) 46 and/or program product 44 that should be selected.

As is known, installation system 40 can generate a default installation medium 54 for program product 44, which can be provided in response to an order received by catalog system 32. The default installation medium 54 can comprise an installation program for program product 44 that includes all of the possible features 52, as well as installation program(s) for each ancillary program product 46 that may be required in a particular installation of program product 44. Additionally, instructions for the installation can be provided to guide customer 19 through each of the possible scenarios that may be encountered to successfully install program product 44.

Since the default installation medium 54 for program product 44 may comprise a large amount of data and/or complex instructions, it is desirable to customize installation medium 54 based on customer 19. To this extent, profile system 34 can obtain a runtime profile 50 for customer 19. In one embodiment, profile system 34 determines whether runtime profile 50 exists, and if so, whether customer 19 would like to use and/or modify runtime profile 50 to generate installation medium 54. When no runtime profile 50 exists, profile system 34 can determine whether customer 19 wants to create runtime profile 50. In any event, when runtime profile 50 is available, installation system 40 can generate a custom installation medium 54 as described herein. Alternatively, when runtime profile 50 is not available (e.g., customer 19 does not wish to use or create runtime profile 50), installation system 40 can generate the default installation medium 54 as described above.

Runtime profile 50 can comprise data on the relevant computing capabilities of a user runtime environment 16 in which program product 44 is to be installed. For example, runtime profile 50 can include data on the processing capabilities (e.g., number/types of processors, processing speed, etc.), memory capabilities (e.g., cache memory, disk space, etc.), software configuration (e.g., operating system type/version, installed software products and versions, enabled/disabled features, etc.), I/O capabilities (e.g., I/O device(s), driver information, etc.), environment (e.g., a number of machines), and/or the like. The relevant computing capabilities can be defined based on the specific capabilities of user runtime environment 16 that will be exploited by program product 44 when it is installed and executed in user runtime environment 16.

Profile system 34 can obtain runtime profile 50 using any known solution. In one embodiment, profile system 34 provides a profile discovery system 42 for use by customer 19, e.g., via a web site of the software vendor. In particular, customer 19 can execute profile discovery system 42 in user runtime environment 16, and profile discovery system 42 can generate runtime profile 50. To this extent, profile discovery system 42 can automatically determine the relevant computing capabilities within user runtime environment 16 and/or profile discovery system 42 can generate a user interface that enables customer 19 to provide some/all of the relevant computing capabilities within user runtime environment 16, e.g., using a series of prompts. In any event, once generated, profile discovery system 42 can provide runtime profile 50 to profile system 34. Further, profile system 34 can generate an interface that enables customer 19 to modify and/or define runtime profile 50.

When runtime profile 50 is available, runtime system 36 can recreate user runtime environment 16 of customer 19. To this extent, runtime system 36 can generate a recreated runtime environment 18 based on runtime profile 50. Recreated runtime environment 18 can comprise an actual physical recreation of the relevant computing capabilities of user runtime environment 16 (e.g., using the same and/or functionally equivalent hardware and software) or recreated runtime environment 18 can comprise a virtual environment that recreates the relevant computing capabilities of user runtime environment 16 (e.g., using virtualization software or the like).

In any event, customization system 38 can install program product 44 in recreated runtime environment 18. To this extent, customization system 38 can configure program product 44 based on the set of features 52 selected by customer 19. Further, customization system 38 can install each required ancillary program product 46 in recreated runtime environment 18. The installation/configuration of program product 44 and/or ancillary program product(s) 46 in recreated runtime environment 18 can be performed in a known manner. For example, an individual at a software vendor can perform the installation by following the various steps outlined in an instruction manual for the installation. In this case, the individual can determine the various ancillary program product(s) 46 to be installed and/or features of program product 44 to be selected based on runtime profile 50 and features 52.

Once installed, customization system 38 can ensure that program product 44 is operable in recreated runtime environment 18. For example, customization system 38 can test the functionality of various capabilities/features of program product 44 to ensure that they can be successfully performed. Further, customization system 38 can obtain performance data for program product 44 to ensure that the responsiveness of program product 44 is within an acceptable range. When one or more capabilities/features of program product 44 do not function properly and/or the responsiveness of program product 44 is outside of an acceptable range, customization system 38 can determine the cause of the problem(s) and propose one or more solutions.

For example, customization system 38 can determine that the memory and/or processing capabilities may need to be increased in recreated runtime environment 18, one or more software products in recreated runtime environment 18 may need to be reconfigured, and/or the like. To this extent, customization system 38 can configure recreated runtime environment 18 with the proposed solutions to determine whether the problem(s) are corrected. If so, then customization system 38 can provide the proposed solution(s) to customer 19 for review. Customer 19 can select to include the proposed solution(s) with the purchase of program product 44, delay the purchase of program product 44, or the like. When one or more problems cannot be corrected, one or more individuals with the software vendor can attempt to debug and correct the problem(s) and/or customization system 38 can indicate to customer 19 that program product 44 will not function properly in user runtime environment 16.

When program product 44 is operable in recreated runtime environment 18, installation system 40 can generate a custom installation medium 54 based on the installed program product 44 and/or any installed ancillary program product(s) 46. To this extent, custom installation medium 54 can be configured to only include installation programs for the selected features 52 of program product 44 and the required ancillary program product(s) 46, if any. Further, custom installation medium 54 can include program code that automatically reconfigures one or more computing resources of user runtime environment 19, which are required in order for program product 44 to operate properly. In this manner, customer 19 can readily install program product 44 in user runtime environment 42 without the need for stepping through detailed instructions.

In one embodiment, the custom installation medium 54 can comprise an image of the installed program product 44 and/or ancillary program product(s) 46 in recreated runtime environment 18. The image can comprise each installed file and its corresponding location in the file system. In this case, installation medium 54 only requires a single installation program to copy the image into user runtime environment 16. Further, installation medium 54 can act as a backup of the installed program product 44 in case it later becomes corrupted, lost, or otherwise requires recreation.

In any event, once installation medium 54 has been generated, installation system 40 can provide installation medium 54 for use by customer 19 in any known manner. For example, installation medium 54 can be provided on one or more portable storage devices (e.g., CDs) and/or via an electronic distribution over a network, such as the Internet. Subsequently, customer 19 can install program product 44 in user runtime environment 16 and begin using the program product 44.

By generating recreated runtime environment 18, a software vendor can perform some testing of program product 44 after its release. In particular, the various runtime environments in which program product 44 may be installed can be tested “on demand” as customers 19 seek to purchase program product 44. Further, the software vendor can configure/tune program product 44 so that it executes best for the particular runtime environment. Still further, the software vendor can store recreated runtime environment 18 in a manner that it can be readily regenerated. In this manner, the software vendor can utilize recreated runtime environment 18 to provide improved customer support to customer 19.

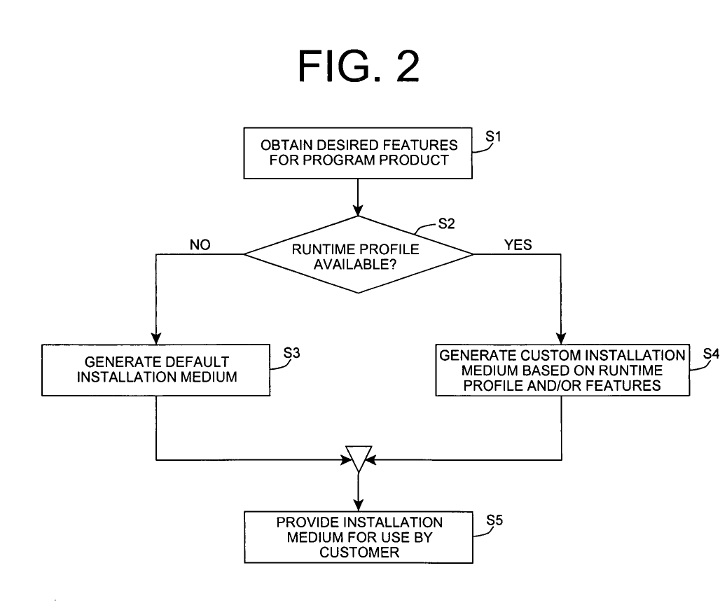

Other aspects of the invention provide methods relating to the generation of installation medium 54 for program product 44. For example, the generation of installation medium 54 can be performed when processing an order. To this extent, FIG. 2 shows illustrative method steps for processing an order for program product 44 according to an embodiment of the invention. Referring to FIGS. 1 and 2, in step S1, catalog system 32 can obtain a set of desired features 52 for program product 44 from customer 19. In step S2, profile system 34 can determine if a runtime profile 50 for customer 19 is available. When runtime profile 50 is not available, then in step S3, installation system 40 can generate a default installation medium 54 for program product 44. However, when runtime profile 50 is available, then in step S4, installation system 40 can generate a custom installation medium 54 based on runtime profile 50 and/or features 52. In either case, in step S5, installation system 40 can provide installation medium 54 for use by customer 19.

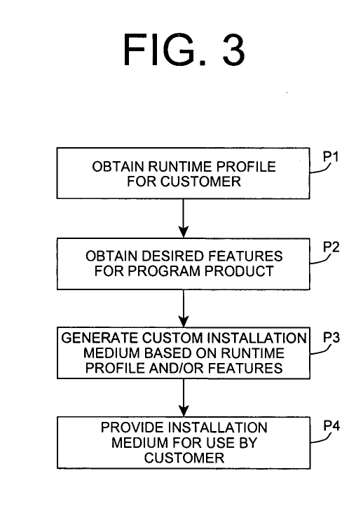

Similarly, FIG. 3 shows alternative method steps for processing an order for program product 44 (FIG. 1) according to an embodiment of the invention. Referring to FIGS. 1 and 3, in step P1, profile system 34 can obtain runtime profile 50 for customer 19. In step P2, catalog system 32 can obtain a set of desired features 52 for program product 44 from customer 19. In step P3, installation system 40 can generate a custom installation medium 54 based on runtime profile 50 and/or features 52. In step P4, installation system 40 can provide installation medium 54 for use by customer 19. It is understood that the various method steps of FIGS. 2 and 3 are only illustrative. To this extent, the order of the steps can be altered, additional steps can be performed, and/or fewer steps can be performed as will be recognized by one in the art.

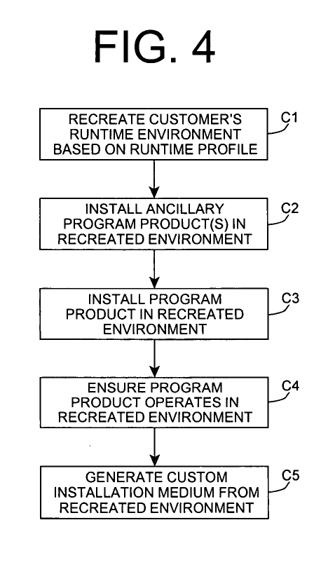

In both step S4 (FIG. 2) and step P3 (FIG. 3), installation system 40 can generate a custom installation medium 54 based on runtime profile 50 and/or features 52. To this extent, FIG. 4 shows illustrative method steps for generating custom installation medium 54 according to an embodiment of the invention. Referring to FIGS. 1 and 4, in step C1, runtime system 36 can recreate the user runtime environment 16 of customer 19 based on runtime profile 50. In step C2, customization system 38 can install any required ancillary program product(s) 46 in the recreated runtime environment 18. In step C3, customization system 38 can install program product 44 in the recreated runtime environment 18. In step C4, customization system 38 can ensure that program product 44 operates in recreated runtime environment 18. In step C5, installation system 40 can generate custom installation medium 54 from recreated runtime environment 18.

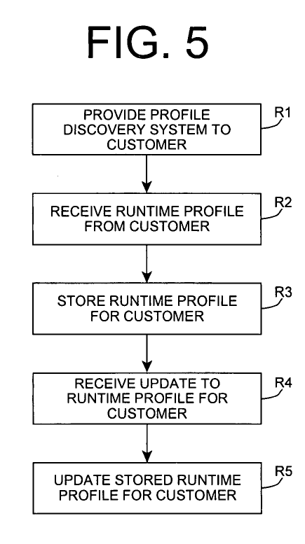

Returning to FIG. 1, profile system 34 can manage runtime profile(s) 50 for one or more customers 19 using any known solution. For example, FIG. 5 shows illustrative method steps for managing runtime profile 50 according to an embodiment of the invention. Referring to FIGS. 1 and 5, in step R1, profile system 34 can provide profile discovery system 42 for use by customer 19. In step R2, profile system 34 can receive runtime profile 50 from customer 19 (e.g., from profile discovery system 42 executing in user runtime environment 16). In step R3, profile system 34 can store runtime profile 50 for customer 19 in a long-term storage system 22B. Subsequently, runtime profile 50 can be used by runtime system 36 and/or other systems as required. In any event, in step R4, profile system 34 can receive one or more updates to runtime profile 50. For example, customer 19 may use a user interface to update runtime profile 50 and/or profile discovery system 42 can automatically detect and provide one or more updates for runtime profile 50 to profile system 34. Regardless, in step R5, profile system 34 can update the stored runtime profile 50 for customer 19 to ensure that runtime profile 50 matches the current user runtime environment 16.

While generally shown and described herein as a method and system for generating an installation medium 54 (FIG. 1) and/or processing an order for program product 44 (FIG. 1), it is understood that the invention further provides various alternative embodiments. For example, in one embodiment, the invention provides a computer-readable medium that includes computer program code to enable a computer infrastructure to generate installation medium 54 and/or process an order for program product 44. To this extent, the computer-readable medium includes program code, such as interface system 30 (FIG. 1), that implements one or more of the various process steps described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as a software vendor, could offer to generate an installation medium 54 (FIG. 1) and/or process an order for program product 44 (FIG. 1) as described above. In this case, the service provider can manage (e.g., create, maintain, support, etc.) a computer infrastructure, such as computer infrastructure 12 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for generating an installation medium 54 (FIG. 1) and/or processing an order for program product 44 (FIG. 1). In this case, a computer infrastructure, such as computer infrastructure 12 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 14 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of generating an installation medium for a program product, the method comprising:
determining whether a runtime profile for a customer is available; and
when the runtime profile is available:
recreating a runtime environment of the customer based on the runtime profile;
installing the program product in the runtime environment;
ensuring that the program product is operable in the runtime environment; and
generating a custom installation medium based on the installed program product.

2. The method of claim 1, further comprising, when the runtime profile is not available, generating a default installation medium for the program product.

3. The method of claim 1, further comprising obtaining the runtime profile for the customer.

4. The method of claim 3, wherein the obtaining comprises:
providing a profile discovery system for use by the customer; and
receiving the runtime profile from the profile discovery system.

5. The method of claim 1, further comprising:
obtaining a set of desired features for the program product; and
when the runtime profile is available, configuring the program product based on the set of desired features.

6. The method of claim 1, wherein the runtime environment comprises a virtual environment.

7. The method of claim 1, further comprising, when the runtime profile is available, installing an ancillary program product for the program product, wherein the custom installation medium is further based on the installed ancillary program product.

8. A system for generating an installation medium for a program product, the system comprising:
a system for determining whether a runtime profile for a customer is available; and
a system for generating a custom installation medium when the runtime profile is available, the system for generating including:
a system for recreating a runtime environment of the customer based on the runtime profile;
a system for installing the program product in the runtime environment;
a system for ensuring that the program product is operable in the runtime environment; and
a system for generating the custom installation medium based on the installed program product.

9. The system of claim 8, further comprising a system for generating a default installation medium for the program product when the runtime profile is not available.

10. The system of claim 8, further comprising a system for obtaining the runtime profile for the customer.

11. The system of claim 10, wherein the system for obtaining comprises:
a system for providing a profile discovery system for use by the customer; and
a system for receiving the runtime profile from the profile discovery system.

12. The system of claim 8, further comprising:
a system for obtaining a set of desired features for the program product; and
a system for configuring the program product based on the set of desired features when the runtime profile is available.

13. The system of claim 8, wherein the runtime environment comprises a virtual environment.

14. The system of claim 8, further comprising a system for installing an ancillary program product for the program product when the runtime profile is available, wherein the custom installation medium is further based on the installed ancillary program product.

15. The system of claim 8, wherein the custom installation medium comprises an image of the installed program product.

16. A method of generating an installation medium for a program product, the method comprising:
obtaining a runtime profile for a customer;
recreating a runtime environment of the customer based on the runtime profile;
installing the program product in the runtime environment;
ensuring that the program product is operable in the runtime environment; and
generating a custom installation medium based on the installed program product.

17. The method of claim 16, wherein the obtaining comprises:
providing a profile discovery system for use by the customer; and
receiving the runtime profile from the profile discovery system.

18. The method of claim 16, further comprising:
obtaining a set of desired features for the program product; and
configuring the program product based on the set of desired features.

19. The method of claim 16, further comprising installing an ancillary program product for the program product, wherein the custom installation medium is further based on the installed ancillary program product.

20. A method of deploying a system for generating an installation medium for a program product, the method comprising:
generating a computer infrastructure operable to:
determine whether a runtime profile for a customer is available; and
when the runtime profile is available:
recreate a runtime environment of the customer based on the runtime profile;
install the program product in the runtime environment;
ensure that the program product is operable in the runtime environment; and
generate a custom installation medium based on the installed program product.
